(19) United States
(12) Patent Application Publication
(10) Pub. No.: US 2010/0214390 A1
(43) Pub. Date: Aug. 26, 2010

(54) Image Forming Apparatus and Latent Image Carrier Unit

(75) Inventors: Kiyoshi TSUJINO, Matsumoto-shi (JP); Ken IKUMA, Suwa-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/686,997

(22) Filed: Jan. 13, 2010

(30) Foreign Application Priority Data
Feb. 25, 2009 (JP) 2009-043225

(51) Int. Cl. B41J 2/45

(52) U.S. Cl. 347/238

(57) ABSTRACT

An image forming apparatus is provided. The image forming apparatus includes a latent image carrier on which a latent image is formed, a line head that exposes the latent image carrier, and a developing section that develops the latent image. The line head includes a substrate, a light emitting element disposed on the substrate in a first direction, and a wiring installed on the substrate so as to be withdrawn from one end of the substrate in a second direction perpendicular to or substantially perpendicular to the first direction. The one end is disposed to be the developing section side.

### BACKGROUND

1. Technical Field

The present invention relates to an image forming apparatus and a latent image carrier unit.

2. Related Art

An image forming apparatus, such as a copying machine or a printer, using an electrophotographic system includes an exposure unit that forms an electrostatic latent image by exposing an outer surface of a photosensitive body to a light. A line head is known as such an exposure unit (e.g., see JP-A-2008-139558).

For example, the line head disclosed in JP-A-2008-139558 includes an optical head with a plurality of light emitting elements installed on a glass substrate, an interconnection substrate with an electronic circuit installed on a glass epoxy substrate, and an FPC (Flexible Printed Circuit) that connects the optical head and the interconnection substrate. Such a line head can densely form the light emitting element with high precision by employing an organic electroluminescence element as the light emitting element, thereby promoting a high-quality picture.

In the line head disclosed in JP-A-2008-139558, however, there is a case in which the FPC is influenced by an unexpected electromagnetic effect (an adverse electromagnetic effect) from the exterior. As a result, there is a case in which the FPC is mixed with noise (an electromagnetic noise) from the external electromagnetic effect to deteriorate an exposure treatment characteristic. Also, according to the image, forming apparatus including such a line head, the exterior (other electric circuits in the image forming apparatus) is influenced by unexpected electromagnetic effects from the FPC. As a result, there is a case in which the quality of the obtained image is deteriorated.

In particular, according to such a line head, the FPC is withdrawn from one end side of the line head in a widthwise direction thereof, and a portion that emits light (a light emitting portion) is eccentrically located at the other end side. However, since the FPC is installed to be a charger side, the FPC is easily influenced by unexpected electromagnetic effects (adverse electromagnetic effect) from the charger.

In addition, with the line head disclosed in JP-A-2008-139558, since the light emitting portion is installed to be a developer side, if the distance between the charger and the developer is shortened according to the downsizing of the image forming apparatus, the distance between an exposing position by the line head and a developing position by the developer is shortened. As a result, if wanting to promote and increase in the speed of performance, the time needed until the surface of the photosensitive body is changed into a potential required for development after the surface of the photosensitive body is subjected to the exposure treatment cannot be ensured. Therefore, there is concern that satisfactory development is not performed.

### SUMMARY

An advantage of some aspects of the invention is to provide an image forming apparatus and a latent image carrier unit, which can obtain an image of high quality while promoting downsizing and increasing speed.

According to an aspect of the invention, there is provided an image forming apparatus including: a latent image carrier on which a latent image is formed; a line head that exposes the latent image carrier; and a developing section that develops the latent image, wherein the line head includes a substrate; a light emitting element disposed on the substrate in a first direction; and a wiring installed on the substrate so as to be withdrawn from one end of the substrate in a second direction perpendicular to or substantially perpendicular to the first direction, in which the one end is disposed to be the developing section side.

In the image forming apparatus according to the invention, it is preferable that the line head includes a lens array that focuses a light from the light emitting element, and the lens array is disposed at a position shifted to the other end side opposite to one end side with respect to an imaginary center line of the substrate in a second direction.

In the image forming apparatus according to the invention, it is preferable that the line head includes a shield member having a magnetic shielding property and disposed to cover the wiring.

In the image forming apparatus according to the invention, it is preferable that the line head includes a semiconductor device constituting at least a portion of a driving circuit that drives the light emitting element, and the semiconductor device is disposed at a position shifted to the one end side with respect to an imaginary center line of the substrate in a second direction.

In the image forming apparatus according to the invention, it is preferable that the semiconductor device is disposed on the substrate.

In the image forming apparatus according to the invention, it is preferable that the semiconductor device is disposed on the wiring.

According to another aspect of the invention, there is provided a latent image carrier unit including a latent image carrier on which a latent image is formed; a line head that forms the latent image on the latent image carrier; and a developing section that develops the latent image, wherein the line head includes a substrate; a light emitting element disposed on the substrate in a first direction; and a wiring installed on the substrate so as to be withdrawn from one end of the substrate in a second direction perpendicular to or substantially perpendicular to the first direction, in which the one end of the line head is disposed to be the developing section side.

With the image forming apparatus and the latent image carrier unit including the above configuration according to the invention, it can obtain an image of high quality while promoting the downsizing.

### BRIEF DESCRIPTION OF THE DRAWINGS

The invention will be described with reference to the accompanying drawings, wherein like numbers reference like elements.

FIG. 1 is a schematic view showing the entire configuration of an image forming apparatus according to a first embodiment of the invention.

FIG. 2 is a transverse cross-sectional view of a line head equipped in the image forming apparatus shown in FIG. 1.

FIG. 3 is a perspective view showing a light emitting substrate unit, a lens array, and a support member equipped in the line head shown in FIG. 2.

FIG. 4 is a cross-sectional view schematically showing the configuration of a light emitting element equipped in the line head shown in FIG. 2.

FIG. 5 is a view showing the configuration of a control system of the line head shown in FIG. 2.

FIG. 6 is a view explaining a modified embodiment of the control system shown in FIG. 5.

FIG. 7 is a schematic view showing the entire configuration of an image forming apparatus according to a second embodiment of the invention.

FIG. 8 is a transverse cross-sectional view of a line head equipped in the image forming apparatus shown in FIG. 7.

FIG. 9 is a transverse cross-sectional view of a developer unit according to a third embodiment of the invention.

FIG. 10 is a perspective view showing the entire configuration of an image forming apparatus according to a fourth embodiment of the invention.

### DESCRIPTION OF EXEMPLARY EMBODIMENTS

An image forming apparatus and a latent image carrier unit according to the invention will now be described in detail based on preferred embodiments with reference the accompanying drawings.

### First Embodiment

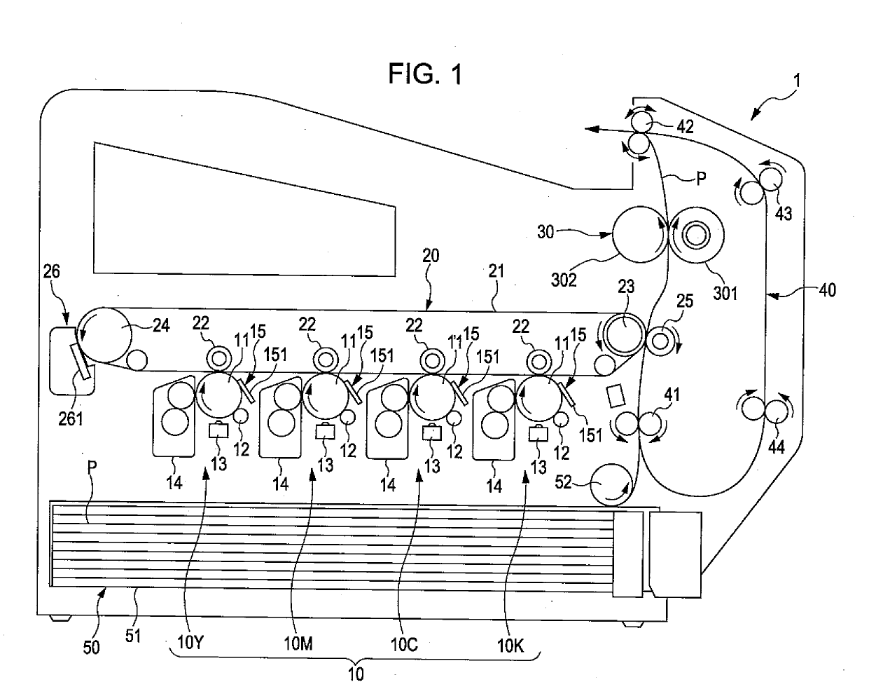

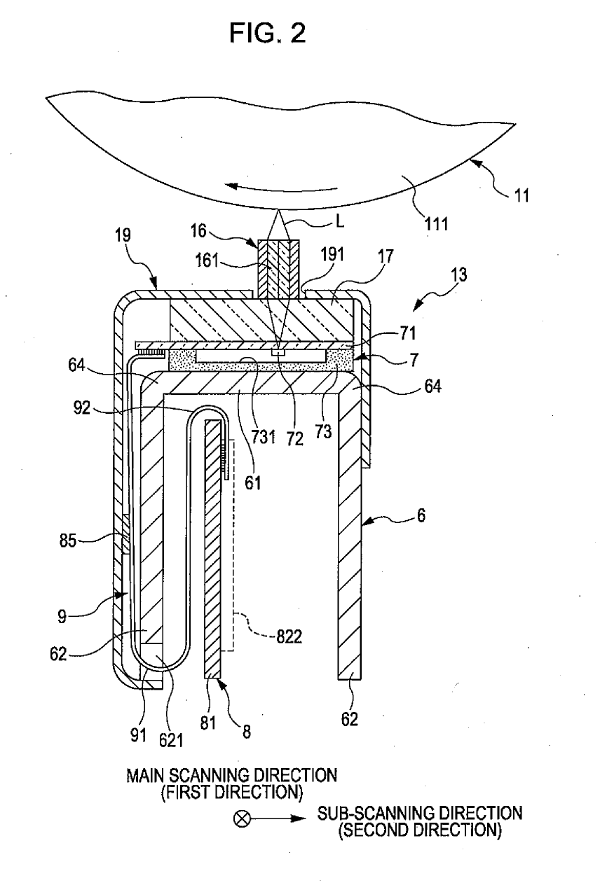

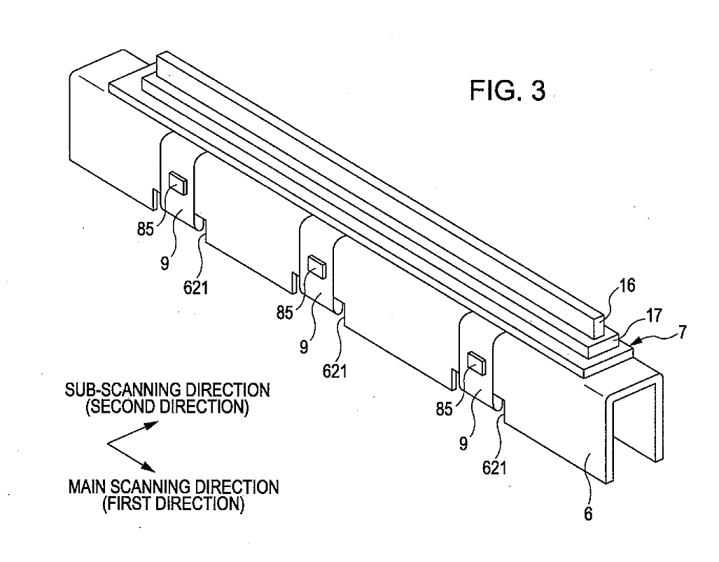

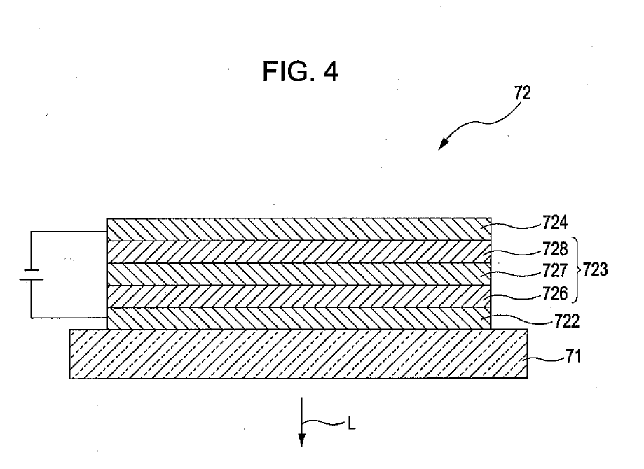

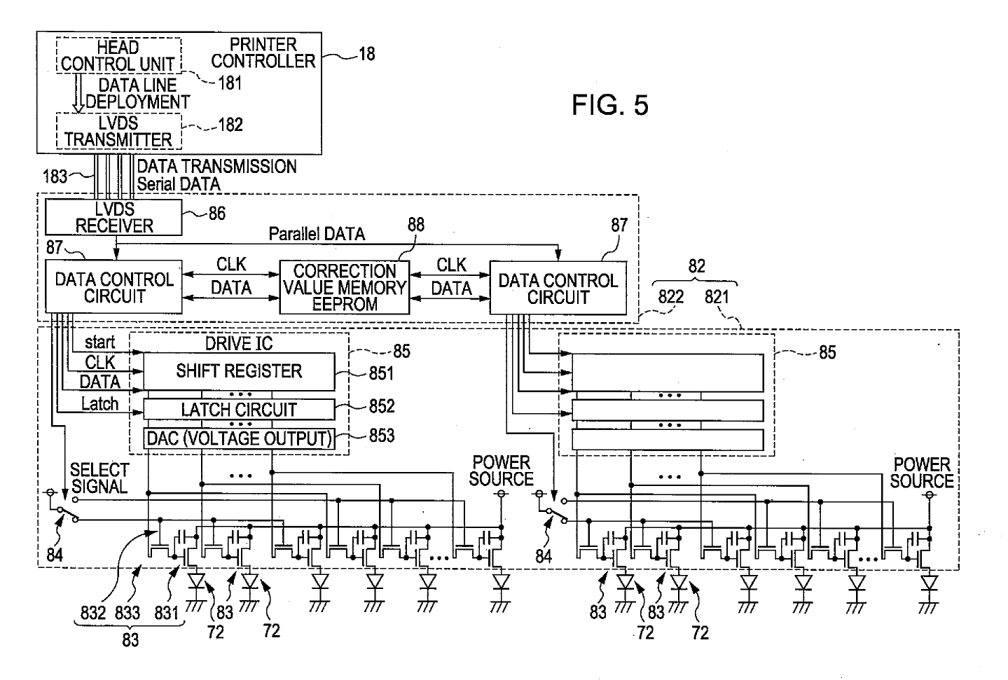

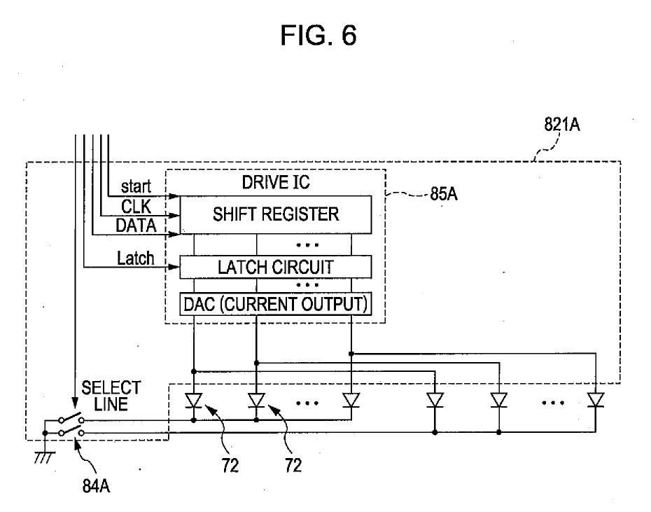

FIG. 1 is a schematic view showing the entire configuration of an image forming apparatus according to the first embodiment of the invention. FIG. 2 is a transverse cross-sectional view of a line head equipped in the image forming apparatus shown in FIG. 1. FIG. 3 is a perspective view showing a light emitting substrate unit, a lens array, and a support member equipped in the line head shown in FIG. 2. FIG. 4 is a cross-sectional view schematically showing the configuration of a light emitting element equipped in the line head shown in FIG. 2. FIG. 5 is a view showing the configuration of a control system of the line head shown in FIG. 2. FIG. 6 is a view explaining a modified embodiment of the control system shown in FIG. 5. In this instance, for descriptive convenience, the upper sides in FIGS. 1 to 4 are hereinafter referred to as “upper”, and the lower sides are referred to as “lower”.

### Image Forming Apparatus

The image forming apparatus 1 shown in FIG. 1 is a printer of an electrophotographic type which can record an image on a recording medium P through a series of image forming processes including a charging step, an exposure step, a development step, a transfer step and a fixing step. In this embodiment, the image forming apparatus 1 is a color printer employing a so-called tandem system.

The image forming apparatus 1 includes, as shown in FIG. 1, an image forming unit 10 for the charging step, the exposure step and the development step, a transfer unit 20 for the transfer step, a fixing unit 30 for the fixing step, a transport mechanism 40 for transporting the recording medium P such as paper, and a paper feeding unit 50 for feeding the recording medium P to the transport mechanism 40.

The image forming unit 10 includes four image forming stations: an image forming station 10Y that forms a yellow toner image; an image forming station 10M that forms a magenta toner image; an image forming station 10C that forms a cyan toner image; and an image forming station 10K that forms a black toner image.

Each of the image forming stations 10Y, 10C, 10M and 10K has a photosensitive drum (photosensitive body) 11 which is a latent image carrier for carrying an electrostatic latent image, and the charging unit (charger) 12, a line head (exposure unit) 13, a development device (developing section) 14, and a cleaning unit 15 are disposed around the photosensitive drum (at the outer circumference thereof). Here, each of the image forming stations 10Y, 10C, 10M and 10K has the substantially same configuration, except for different colors of the toners to be used.

The photosensitive drum 11 has an entire cylindrical shape, and can be rotated around its axis in a direction indicated by an arrow in FIG. 1. The photosensitive drum 11 is provided with a photosensitive layer (not shown) in the vicinity of its outer circumference (cylindrical surface). The outer circumference of the photosensitive drum 11 has a light receiving surface 111 for receiving the light L (emission light) from the line head 13 (see FIG. 2).

The charging unit 12 charges uniformly the light receiving surface 111 of the photosensitive drum 11 by corona charging or the like.

The line head 13 receives image information from a host computer (not shown) such as a personal computer, and according to the receipt of the image information, irradiates the light L toward the light receiving surface 111 of the photosensitive drum 11. If the light receiving surface 111, which is uniformly charged, of the photosensitive drum 11 is irradiated by the light L, a latent image (electrostatic latent image) corresponding to an irradiation pattern of the light L is formed on the light receiving surface 111. In this instance, the configuration of the line head 13 will be described hereinafter.

The development device 14 includes a storage part (not shown) for storing a toner, and supplies and imparts the toner onto the light receiving surface 111 of the photosensitive drum 11 from the storage part. If the toner is imparted onto the light receiving surface 111 formed with the electrostatic latent image, the latent image is visualized (developed) as a toner image.

The cleaning unit 15 includes a cleaning blade 151 made of rubber and abutting against the light receiving surface 111 of the photosensitive drum 11. The toner remaining on the photosensitive drum 11 after primary transfer which will be described hereinafter is scraped and dropped by the cleaning blade 151, thereby removing the toner.

The transfer unit 20 is adapted to totally transfer the toner image of each color formed on the photosensitive drums 11 of the image forming stations 10Y, 10M, 10C and 10K as described above onto the recording medium P.

In each of the image forming stations 10Y, 10M, 10C and 10K, while the photosensitive drum 11 rotates once, charging of the light receiving surface 111 of the photosensitive drum 11 by the charging unit 12, the exposure of the light receiving surface 111 by the line head 13, the supply of the toner onto the light receiving surface 111 by the development device 14, the primary transfer of the toner image onto an intermediate transfer belt 21 by a primary transfer roller 22 which will be described hereinafter, and cleaning of the light receiving surface 111 by the cleaning unit 15 are sequentially performed.

The transfer unit 20 includes the intermediate transfer belt 21 of an endless belt shape, and the intermediate transfer belt 21 is stretched by the plurality (four in the configuration shown in FIG. 1) of primary transfer rollers 22, a driving roller 23, and a driven roller 24. The intermediate transfer belt 21 is rotatably driven by the rotation of the driving roller 23 at the substantially same circumferential velocity as that of the photosensitive drum 11 in a direction indicated by an arrow shown in FIG. 1.

Each of the primary transfer rollers 22 is disposed opposite to the photosensitive drum 11, with the corresponding intermediate transfer belt 21 being interposed between the photosensitive drum and the primary transfer roller, and is adapted to transfer (primary transfer) the toner image of monochrome from the corresponding photosensitive drum 11 onto the intermediate transfer belt 21. The primary transfer roller 22 is applied by a primary transfer voltage (primary transfer bias) of polarity contrary to the charge polarity of the toner.

One color of yellow, magenta, cyan and black is carried on the intermediate transfer belt 21. For example, at the time of formation of full-color toner image, four colors of yellow, magenta, cyan and black are sequentially overlapped and transferred onto the intermediate transfer belt 21 to form the full-color toner image as an intermediate transfer image.

In addition, the transfer unit 20 includes a secondary transfer roller 25 disposed opposite to the driving roller 23, in which the intermediate transfer belt 21 is interposed therebetween, and a cleaning unit 26 disposed opposite to the driven roller 24, in which the intermediate transfer belt 21 is interposed therebetween.

The secondary transfer roller 25 is adapted to transfer (secondarily transfer) the toner image (an intermediate transfer image), such as monochrome or full colors, formed on the intermediate transfer belt 21 onto the recording medium P, such as paper, film or cloth, supplied from the paper feeding unit 50. At the time of the secondary transfer, the secondary transfer roller 25 is pressed against the intermediate transfer belt 21, and simultaneously is applied by a secondary transfer voltage (secondary transfer bias). At the time of the secondary transfer, the driving roller 23 also serves as a backup roller of the secondary transfer roller 25.

The cleaning unit 26 includes a cleaning blade 261 made of rubber and abutting against the surface of the intermediate transfer belt 21. The toner remaining on the intermediate transfer belt 21 after the secondary transfer is scraped and dropped by the cleaning blade 261, thereby removing the toner.

The fixing unit 30 includes a fixing roller 301 and a pressing roller 302 pressed against the fixing roller 301, in which the recording medium P passes between the fixing roller 301 and the pressing roller 302. Also, the inside of the fixing roller 301 is equipped with a heater that heats the outer circumference of the fixing roller 301. With the fixing unit 30 having the above configuration, the recording medium P secondarily transferred with the toner image is heated and pressed while passing between the fixing roller 301 and the pressing roller 302, so that the toner image is thermally bonded to the recording medium P and thus is fixed as a permanent image.

The transport mechanism 40 includes a pair of resist rollers 41 that transport the recording medium P to the secondary transfer section between the secondary transfer roller 25 and the intermediate transfer belt 21 which are described above, while measuring a paper feeding timing, and pairs of transport rollers 42, 43 and 44 that hold and transport the recording medium P which has been subjected to the fixing treatment by the fixing unit 30.

In the case in which the image is formed only on one surface of the recording medium P, the transport mechanism 40 holds and transports the recording medium P, of which one surface has been subjected to the fixing treatment by the fixing unit 30, by using the pair of transport rollers 42, and discharges the recording medium to the outside of the image forming apparatus 1. Also, in the case in which the image is formed on both surfaces of the recording medium P, after the recording medium P, of which one surface has been subjected to the fixing treatment by the fixing unit 30, is pinched by the pair of transport rollers 42, the pair of the transport rollers 42 is reversely driven. Simultaneously, the pairs of transport rollers 43 and 44 are driven, so that the recording medium P is turned upside down, and then is returned to the pair of resist rollers 41. The image is formed on the other surface of the recording medium P by the same operation as the above description.

The paper feeding unit 50 includes a paper feeding cassette 51 that stores unused recording medium P therein, and a pickup roller 52 that feeds a sheet of the recording medium P one by one from the paper feeding cassette 51 toward the pair of resist rollers 41.

### Line Head

The line head 13 will now be described.

The line head 13 is disposed opposite to the outer circumference (more specifically, the light receiving surface 111) of the photosensitive drum 11 (see FIGS. 1 and 2).

The line head 13 includes, as shown in FIG. 2, a support member 6, a light emitting substrate unit 7, a circuit substrate unit 8, a wiring unit (flexible printed circuit substrate) 9, a lens array 16, a spacer 17 and a light shielding member 19.

With the line head 13, the light L emitted from the light emitting substrate unit 7 transmits the spacer 17 and the lens array 16 to irradiate the light receiving surface 111 of the photosensitive drum 11.

Each part constituting the line head 13 will now be successively described in detail. In this instance, for descriptive convenience, a longitudinal direction (a first direction) the first substrate 71 of the light emitting substrate unit 7 is referred to as “a main scanning direction”, and a widthwise direction (a second direction) is referred to as “a sub-scanning direction”.

The support member 6 is formed in an elongated shape (longitudinal shape), and is installed along an axial direction (the main scanning direction) of the photosensitive drum 11.

The support member 6 is formed by, for example, bending a metal plate, and as shown in FIG. 2, includes a substrate mounting portion 61, a pair of leg portion 62, and a bent portion 64 formed between the substrate mounting portion 61 and the leg portions 62. The support member 6 is formed in the shape of a substantially U-shaped transverse cross section.

The substrate mounting portion 61 is installed along a substrate surface of the first substrate 71 at the transverse cross section (a cross section perpendicular to a longitudinal direction of the first substrate 71 which will be described below) shown in FIG. 2.

The substrate mounting portion 61 is formed in the shape of an elongated plate, and the first substrate 71 of the light emitting substrate unit 7 which will be described below is mounted on one surface side (an upper side in FIG. 2) of the substrate mounting portion, in which a sealing member 73 is interposed between the substrate mounting portion and the first substrate. The substrate mounting portion 61 supports the first substrate 71.

The pair of leg portions 62 is extended from both ends of the substrate mounting portion 61 in the widthwise direction (a sub-scanning direction) towards the side opposite to the first substrate 71. That is, the pair of leg portions 62 is downwardly extended from both ends (that is, both ends in a short direction) of the substrate mounting portion 61 in the widthwise direction. Consequently, the support member 6 is provided with the light emitting substrate unit 7 at the outer side thereof.

If the support member 6 is made of a metal material, the support member has an electromagnetic shielding property, and is disposed to cover a portion of the circuit substrate unit 8 (the second circuit section) and the wiring unit 9, which are described below. Thus, it is possible to prevent an adverse electromagnetic effect from exerting between a portion of the circuit substrate unit 8 (the second circuit section) and the wiring unit 9 and the exterior. As a result, the exposure characteristic of the line head 13 can be enhanced.

In addition, in the pair of leg portions 62, one leg portion 62 is provided with a cut portion 621 in which the wiring unit 9 described below is inserted. Since the cut portion 621 is disposed, although the wiring unit 9 is disposed as described below, a clearance between a lower end of the one leg portion 62 and the light shielding member 19 (a shield member) is shortened, so that the electromagnetic shielding property of the light shielding member 19 can be enhanced.

The support member 6 is formed to have the transverse cross section of a substantially U-shape, as described above, thereby increasing the rigidity of the support member 6 with the relatively simple configuration. In addition, the substrate mounting portion 61 supports the first substrate 71, so that the first substrate 71 is stably supported to perform the stably exposure treatment. In particular, since the flatness of the substrate mounting portion 61 is high, the flatness of the first substrate 71 can be maintained at a high state.

Further, in the case in which the support member 6 is made by bending a metal plate, a relatively simple and inexpensive support member can be obtained.

Since the first substrate 71 is installed at the outside of the support member 6, it can be easily assembled as compared with the case in which the first substrate 71 is installed in the support member 6. As a result, the inexpensive line head 13 can be fabricated.

Further, since the first substrate 71 is installed at the outside of the support member 6, the width of the support member 6 can be smaller than that of the first substrate 71. As a result, the width of the line head 13 can be narrowed.

The constituent material of the support member 6 is not particularly limited, and may use various metal materials (in particular, a soft magnetic material). Preferably, iron, stainless steel, aluminum alloy or the like is utilized.

In this way, the support member 6 supports the light emitting substrate unit 7.

The light emitting substrate unit 7 includes the first elongated substrate 71, a plurality of light emitting elements 72 arranged along its longitudinal direction (the first direction) on one surface of the first substrate 71, and a sealing member 73 covering the plurality of light emitting elements 72.

The first substrate 71 is one (a substrate) for supporting the respective light emitting elements 72, and is made of a plate body formed in an elongated shape.

The first substrate 71 is made of a glass material. That is, the first substrate 71 is a glass substrate. The glass substrate has an insulation property and a optical transparency. For this reason, if the first substrate 71 is a glass substrate, organic electroluminescence elements can be formed on the first substrate 71 as the light emitting element 72 in a relatively simple and inexpensive way. Also, the light L can be emitted from the respective light emitting elements 72 of a bottom emission structure through the first substrate 71; as described below. Further, since the flatness of the glass substrate is relatively high, a variance between the light emitting element 72 and the lens array 16 is decreased by employing the glass substrate as the first substrate 71, so that the lens array 16 can focus the light L onto the light emitting surface 111 of the photosensitive drum 11 with high precision.

In addition, since the first substrate 71 is made of the glass material, the heat generated by the light emission of the respective light emitting elements 72 can be effectively radiated to the support member 6 through the first substrate 71.

One surface (the lower surface in FIG. 2) of the first substrate 71 is bonded with the plurality of light emitting elements 72 and the sealing member 73.

The plurality of light emitting elements 72 are arranged along its longitudinal direction (the main scanning direction) on the first substrate 71. Also, each of the light emitting elements 72 is installed in such a way that its optical axis is substantially perpendicular to the substrate surface of the first substrate 71.

Each of the light emitting elements 72 is constituted by an organic EL element (an organic electroluminescence element).

More specifically, each of the light emitting elements 72 includes, as shown in FIG. 4, an anode 722, an organic semiconductor layer 723 formed on the anode 722, and a cathode 724 formed on the organic semiconductor layer 723, which are installed on the first substrate 71.

Further, in this embodiment, the organic semiconductor layer 723 is formed of a stacked body which is constituted by a plurality of layers, in which a hole transport layer 726, a light emitting layer 727 and an electron transport layer 728 are stacked in this order from the anode 722 side to the cathode 724 side.

With the light emitting element 72, if a DC voltage is applied between the anode 722 and the cathode 724, the electron transported through the electron transport layer 728 and the hole transported through the hole transport layer 726 are recombined in the light emitting layer 727. Exciton (exciter) is created by energy irradiated when recombining, and when the exciton is returned to a ground state, the energy is emitted as the light L (fluorescence or phosphorescence). As a result, the light emitting element 72 (the light emitting layer 727) produces luminescence.

In this embodiment, the light emitting element 72 is constituted by an element of a bottom emission structure which extracts the light L from the light emitting layer 727 towards the anode 722 side.

The anode 722 is an electrode for injecting a hole into the organic semiconductor layer 723 (the hole transport layer 726 described below). The constituent material of the anode 722 is not particularly limited. For example, there are oxides, such as ITO (Indium Tin Oxide), SnO₂, Sb-containing SnO₂ and Al-containing ZnO, Au, Pt, Ag, Cu or alloy thereof, and the like, and at least one thereof may be used.

The cathode 724 is an electrode that injects an electron into the organic semiconductor layer 723 (the electron transport layer 728 described below). Also, the cathode 724 has a function of serving as a reflective layer that reflects the light L leaking from the cathode 724 side to the anode 722 side. As a result, it is possible to seize much light intensity of the light L facing the lens array 16 side.

As the constituent material of the cathode 724, there are Li, Mg, Ca, Sr, La, Ce, Er, Eu, Sc, Y, Yb, Ag, Cu, Al, Cs, Rb or an alloy thereof, and the like, and at least one thereof may be used.

The organic semiconductor layer 723 is installed between the anode 722 and the cathode 724. The organic semiconductor layer 723 includes the hole transport layer 726, the light emitting layer 727 and the electron transport layer 728, ad described above, which are stacked on the anode 722 in this order.

The hole transport layer 726 has a function of transporting the hole injected from the anode 722 to the light emitting layer 727.

The hole transporting layer 726 may be made of any constituent material (hole transporting material), if it has hole transferring capacity. A compound of conjugated system is preferable. Since the compound of conjugated system can very smoothly transport the hole in its nature due to the peculiar spread of electron cloud, the hole transferring capacity is particularly excellent.

As the hole transporting material, there are an aryl cycloalkane-based compound such as 1,1-bis(4-di-para-triaminophenyl) cyclohexane, an aryl amine-based compound such as 4,4′,4″-trimethyltriphenylamine, a phenylene diamine-based compound such as N,N,N′,N′-tetraphenyl-para-phenylene diamine, a triazole-based compound such as triazole, an imidazole-based compound such as imidazole, an oxadiazole-based compound such as 1,3,4-oxadiazole, an anthracene-based compound such as anthracene, a fluorenone-based compound such as fluorenone, an aniline-based compound such as polyaniline, a phthalocyanine-based compound such as phthalocyanine, and the like, and one kind or two or more kinds thereof may be combined and used.

The electron transport layer 728 has a function of transporting the electron injected from the cathode 724 to the light emitting layer 727.

As the constituent material (electron transporting material) of the electron transport layer 728, there are a benzene-based compound (a starburst compound) such as 1,3,5-tris[(3-phenyl-6-tri-fluoromethyl) quinoxalin-2-yl] benzene(TPQ1), a naphthalene-based compound such as naphthalene, a phenanthrene-based compound such as phenanthrene, a chrysene-based compound such as chrysene, a pherylene-based compound such as pherylene, an anthracene-based compound such as anthracene, an oxadiazole-based compound such as oxadiazole, a triazole-based compound such as triazole, and the like, and one kind or two or more kinds thereof may be combined and used.

Further, the light emitting layer 727 may be made of any material, if it is made of a material which, at the time of application of a voltage, can inject the hole from the anode 722 side, inject the electron from the cathode 724 side, and provide a place where the hole and the electron recombine to each other.

As the constituent material (light emitting material) of the light emitting layer 727, there are a benzene-based compound such as 1,3,5-tris[(3-phenyl-6-tri-fluoromethyl) quinoxaline-2-yl] benzene(TPQ1) and 1,3,5-tris[(3-(4-t-butylphenyl)-6-trisfluoromethyl) quinoxaline-2-yl] benzene(TPQ2), a metal or metal-free phthalocyanine-based compound such as phthalocyanine, copper phthalocyanine (CuPc), and iron phthalocyanine, a low molecular-based compound such as tris(8-hydroxyquinolinolate) aluminum (Alq₃) and factris(2-phenylpyridine)iridium) (Ir(ppy)₃), and a polymer-base compound such as oxadiazole-based polymer, triazole-based polymer and carbazole-based polymer, and one kind or two or more kinds thereof may be combined to obtain the light L having intended emission color.

In this embodiment, each of the light emitting elements 72 is adapted to emit a red light. Here, as the light emitting layer 727 for emitting the red light, for example, there are (4-dicyanomethylene)-2-methyl-6-(paradimethylaminostyryl)-4H-pyran) (DCM), Nile red, and the like. In this instance, each of the light emitting elements 72 is not limited the configuration in which the light emitting element emits the red light, may be constituted to emit monochromatic light of a different color or a white light. In this way, in the organic EL element, the light L emitted from the light emitting layer 727 can be appropriately set to have a monochromatic light of an arbitrary color according to the constituent material of the light emitting layer 727.

In general, since a spectral sensitivity characteristic of the photosensitive drum (the photosensitive body) used in the electrophotographic process is set to have a peak at a near-infrared region from a red color which is an emission wavelength of a semiconductor laser, it is preferable to use a red-light emitting material, as described above.

If each of the light emitting elements 72 is constituted by the organic EL element (the organic electroluminescence element), an interval (a pitch) between the light emitting elements 72 can be set to be relatively narrow. That is, this makes recording density on the recording medium P relatively high, when the image is recorded on the recording medium P. Accordingly, the recording medium P carried with a shaper image can be obtained.

In addition, if each of the light emitting elements 72 is constituted by the organic EL element, it is possible to suppress the number of the light emitting elements 72 in the widthwise direction (the sub-scanning direction) of the first substrate 71 and to increase the displaced density of the light emitting elements 72 in the longitudinal direction (the main scanning direction) of the first substrate 71. Further, when the light emitting elements 72 are formed, TFTs or wiring which constitutes a portion of a driving circuit for driving the light emitting elements 72 can be formed on the first substrate 71 together with the light emitting elements 72 as a single package. As a result, as the width of the first substrate 71 is suppressed, it is possible to form the inexpensive line head 13.

In this instance, each of the light emitting elements 72 may be provided at its outer circumference with an optical-path adjusting member, such as a reflector, for preventing spread of the light L.

Further, the light emitting element 72 is not limited to an element of a bottom emission structure, and may employ a top emission structure which extracts the light L from the light emitting layer 727 toward the cathode 724 side and then uses the light. In this instance, the light emitting substrate unit 7 is installed by letting the first substrate 71 to be a lower side.

Further, the material or the layer configuration of the organic EL element described above is shown as a typical example, and the operation and the effect of the invention can be equally obtained even though other material or layer configuration is employed.

The sealing member 73 installed on one surface of the first substrate 71 together with the respective light emitting elements 72 is provided with a concave portion 731, as shown in FIG. 2, and an edge portion of the concave portion 731 is bonded to the first substrate 71 by an adhesive or the like. The plurality of the light emitting elements 72 are received in the concave portion 731. Therefore, the sealing member 73 covers the plurality of light emitting elements 72.

The sealing member 73 has a gas barrier property, and the sealing member 73 and the first substrate 71 are hermetically bonded to each other. As a result, each portion constituting the respective light emitting elements 72 is blocked from atmosphere gas containing moisture or oxygen to prevent the oxidization or the deterioration of each portion. Also, it is possible to prevent the adhesion of foreign matters to the respective light emitting elements 72 or the like.

It is preferable that a drying agent and/or a deoxygenating agent is installed in the inside of the concave portion 731 of the sealing member 73. As a result, it is possible to more reliably prevent the oxidization or the deterioration of the respective portions that constitutes the respective light emitting elements 72.

The drying agent is not particularly limited, if it exerts a moisture absorbing effect in the concave portion 731, and various kinds of materials may be used. For example, there are sodium oxide (Na₂O), potassium oxide (K2O), calcium oxide(CaO), barium oxide (BaO), magnesium oxide (MgO), lithium sulfate (Li₂SO₄), sodium sulfate (Na₂SO₄), calcium sulfate (CaSO₄), magnesium sulfate (MgSO₄), cobalt sulfate (CoSO₄), gallium sulfate (Ga₂(SO₄)₃), titanium sulfate (Ti(SO₄)₂), nickel sulfate (NiSO₄), calcium chloride (CaCl₂), magnesium chloride (MgCl₂), strontium chloride (SrCl₂), yttrium chloride (YCl₃), copper chloride (CuCl₂), cesium fluoride (CsF), tantalum fluoride (TaF₅), niobium fluoride (NbF5), calcium bromide (CaBr₂), cerium bromide (CeBr₃), selenium bromide (SeBr₄), vanadium bromide (VBr₂), magnesium bromide (MgBr₂), barium iodide (BaI₂), magnesium iodide (MgI₂), barium perchlorate (Ba(ClO₄)₂), magnesium perchlorate (Mg(ClO₄)₂) and the like.

In addition, as the deoxygenating agent, there are activated carbon, silica gel, activated alumina, molecular sieve, magnesium oxide, ferric oxide, titanium oxide, and the like.

Further, the sealing member 73 has a flat surface opposite to the concave portion 731. As a result, the sealing member 73 is interposed between the first substrate 71 and the support member 6 to bond the first substrate and the support member simply and reliably.

The constituent material of the sealing member 73 is not particularly limited, and a metal material, such as stainless steel, aluminum, or its alloy, a glass material, such as soda-lime glass, silicate glass or the like, a resin material, such as acrylic-based resin, styrene-based resin or the like, and the like may be used. The glass material is preferably used. Problems, such as deformation or damage due to the difference in the liner coefficient of expansion therebetween can be prevented by constituting the sealing member 73 and the first substrate 71 with the glass material.

Meanwhile, the other surface (the upper surface in FIG. 2) of the first substrate 71 is bonded with the lens array 16, with the spacer 17 being interposed between the lens array and the first substrate.

The lens array 16 is installed at the emission side of the light L of the light emitting substrate unit 7.

In particular, the lens array 16 is installed at a position shifted to an end side opposite to an end side which is connected to the first substrate 71 and the wiring unit 9 described below, with respect to the center of the first substrate 71 in the sub-scanning direction (the second direction).

Therefore, as the distance between the charging unit 12 and the development device 14 is shortened according to the downsizing of the image forming apparatus 1, the distance between the exposed position of the light receiving surface 111 by the line head 13 and the developed position by the development device 14 can be largely extended. As a result, even though the speed-up is promoted, a time needed until the exposed portion of the light receiving surface 111 is changed into a potential required for the development after the exposure treatment can be ensured, thereby performing the excellent development.

The lens array 16 includes a plurality of rod lenses 161 of a refraction index distribution type that are arranged to be stacked in two rows in a main scanning direction, and focuses the light from the light emitting element 72.

Each of the rod lenses 161 is installed in such a way that its optical axis becomes a thickness direction of the first substrate 71. Also, each of the rod lenses 161 is made of, for example, a glass material and/or a resin material having optical transparency.

The spacer 17 is installed between the first substrate 71 and the lens array 16 to support the lens array 16 with respect to the first substrate 71 and to define an optical distance between the first substrate 71 and the lens array 16. The spacer 17 is formed in a plate shape, and is made of, for example, a glass material and/or a resin material having optical transparency. By installing the spacer 17, it is possible to adjust the distance between each of the light emitting elements 72 and the lens array 16 in accordance with a thickness of the spacer 17. As a result, the exposure treatment of high precision can be achieved with a relatively simple configuration.

In particular, the spacer 17 is a substrate having optical transparency, and the lens array 16 is bonded to and supported by the spacer 17. As a result, the distance between each of the light emitting elements 72 and the lens array 16 can be defined with a simple and accurate way. Also, since it is not necessary to support the lens array 16 by the light shielding member 19 which will be described below, for example, the thickness of the light shielding member 19 can be thinned, and thus a width of the line head 13 can be narrowed.

In addition, since the spacer 17 is formed in the plate shape, the distance between each of the light emitting elements 72 and the lens array 16 can be defined high precisely and stably.

Further, the spacer 17 is bonded to the first substrate 71. Accordingly, the spacer 17 can be stably supported with respect to the first substrate 71. As a result, the spacer 17 can stably support the lens array 16 with respect to the first substrate 71.

The light shielding member 19 the shield member) is installed so as to cover the spacer 17 from the upper portion. The light shielding member 19 has a function of preventing the light which is not incident onto the lens array 16 which will be described below, from each of the light emitting elements 72, from leaking outwardly.

The light shielding member 19 is provided with an opening portion 191 penetrating each of the light emitting elements 72 in an optical axial direction thereof. The lens array 16 is installed through the opening portion 191 in such a way that the lens array penetrates the light shielding member 19 externally and internally.

The light shielding member 19 is made of a metal material. Accordingly, since the light shielding member 19 serves as an electromagnetic shield, it is possible to prevent an adverse electromagnetic effect from exerting on each of the light emitting elements 72 or its peripheral circuit (the first circuit) from the exterior. Also, it is possible to prevent each of the light emitting elements 72 and its peripheral circuit from exerting an adverse electromagnetic effect on external circuits or the like. As a result, the exposure characteristic of the line head 13 can be enhanced.

The light shielding member 19 can be formed by bending a metal plate (a metal plate thinner than a metal plate for forming the support member 6).

In particular, the light shielding member 19 is disposed in such a way that the left portion in FIG. 2 covers the wiring unit 9 which will be described below. Accordingly, it is possible to prevent the adverse electromagnetic effect from exerting on the wiring unit 9 from the exterior. Also, it is possible to prevent the wiring unit 9 from exerting the adverse electromagnetic effect on the external circuits or the like. As a result, the exposure characteristic of the line head 13 can be enhanced.

In addition, although a high voltage applied to the above-described charging unit 12 leaks, the light shielding member 19 has a function of preventing the leak current from flowing directly in the first substrate 71 (the first circuit section).

A clearance is formed between an edge of the opening portion 191 of the light shielding member 19 and the lens array 16, and the light shielding member 19 and the lens array 16 are not bonded to each other. Accordingly, in the case in which a difference in thermal expansion between the light shielding member 19 and the lens array 16 (in particular, a difference in a coefficient of thermal expansion in the main scanning direction) is large, it is possible to prevent deformation or shift of the lens array 16 due to the difference in thermal expansion. As a result, it is possible to make the exposure characteristic of the line head 13 superior over a long period of time.

Further, the light shielding member 19 is formed to cover the end face of the left leg portion 62 in FIG. 2. Accordingly, the portion of the wiring unit 9 outside the support member 6 is enclosed by one leg portion 62 and the light shielding member 19 (the shield member), thereby enhancing the electromagnetic shielding property (an electromagnetic noise shielding effect) of the light emitting member 19 with respect to the wiring unit 9.

In order to increase the electromagnetic shielding property, it is preferable that the contact resistance between the light shielding member 19 (the shield member) and the support member 6 is set as small as possible, and the contact resistance between the light shielding member 19 and the support member 6 is set as small as possible. Accordingly, for example, in the case in which the end face of the leg portion 62 of the support member 6 comes in contact with the light shielding member 19, it is preferable that the end face of the leg portion 62 is provided with a plurality of bosses, or the end face of the leg portion 62 is threadedly engaged with the light shielding member 19. Also, it is preferable that contact portions between the end face of the leg portion 62 and the light shielding member 19 are installed as dense as possible.

The above-described light emitting substrate unit 7 is connected to the circuit substrate unit 8 through the wiring unit 9.

The circuit substrate unit 8 includes a second substrate 81 and a control circuit 822 serving as a second substrate which is installed on the second substrate 81.

The second substrate 81 is installed in such a way that its substrate surface is in line with the optical axis of each of the light emitting elements 72 which is described above. That is, the substrate surface of the second substrate 81 is installed in a direction perpendicular to or substantially perpendicular to the substrate surface of the above-described first substrate 71. In particular, in this embodiment, the second substrate 81 is installed to be inserted into the inside of an outer circumference of the first substrate 71 when viewing from a plane of the first substrate 71.

The second substrate 81 installed as described above may be installed not so as to have an effect on a width of the line head 13, even though the width of the second substrate 81 is widened due to increased number of elements or circuits to be mounted on the second substrate 81. Accordingly, at least a portion of the above-described driving circuit that drives each of the light emitting elements 72 can be mounted not on the first substrate 71, but on the second substrate 81. As a result, the number of the elements or circuits to be mounted on the first substrate 71 can be minimized, and thus the width of the above-described first substrate 71 can be narrowed. For this reason, the line head 13 has the narrowed width, and thus can allow the image forming apparatus 1 to be compact and inexpensive.

Further, in this embodiment, the second substrate 81 is installed in the vicinity of the leg portion 62 of a connection portion side between the first substrate 71 and the wiring unit 9. Accordingly, the control circuit 822 is installed at a position which is shifted towards the development device 14 from a center of the line head 13 in a widthwise direction (the sub-scanning direction).

Accordingly, it is possible to suppress the electromagnetic effect from exerting on the control circuit 822 from the charging unit 12.

Although the second substrate 81 may use the same constituent material as that of the above-described first substrate 71, it is preferable that a material mixed with a glass material and a resin material (e.g., a mixture material of glass and epoxy resin) is used. That is, it is preferable that the second substrate 81 is a printed substrate. Accordingly, elements or circuit needed to drive each of the light emitting elements 72 can be easily and inexpensively mounted on the second substrate 81. Also, the second substrate 81 can have superior mechanical strength, so that the damage of the second substrate 81 can be prevented at the time of connection of the circuit substrate unit 8 and a printer controller 18 which will be described below.

The control circuit 822 (the second circuit section) of a circuit section 82 which will be described below is installed on the second substrate 81.

As shown in FIG. 5, the line head 13 has the circuit section 82. The circuit section 82 has a driving circuit 821 that drives each of the light emitting elements 72, and the control circuit 822 that controls the operation of the driving circuit 821.

The driving circuit 821 is to drive each of the above-described light emitting elements 72.

In this embodiment, the driving circuit 821 includes a plurality of constant-current driving circuits 83 of a gate voltage holding type, a selection switch 84 and a driver IC 85.

Each of the constant-current driving circuits 83 has a constant-current transistor 831, a voltage holding capacitor 832, and a selection transistor 833.

With each of the constant-current driving circuits 83, if the selection transistor 833 is turned on, a constant current flows in the light emitting element 72 through the constant-current transistor 831 according to the output voltage of the driver IC 85 which will be described below, so that the light emitting element 72 produces luminescence. Also, since the output voltage of the driver IC 85 is held in the voltage holding capacitor 832, even though the selection transistor 833 is turned off, the current continuously flows in the light emitting element 72 to maintain the emission of the light emitting element 72.

The selection switch 84 is switched by a select signal from the control circuit 822 to select the constant-current circuits 83 for every predetermined block. It is possible to set the voltage applied to each of the light emitting elements 72 for every predetermined block by switching the selection switch 84.

The driver IC 85 includes a shift resistor 851, a latch circuit 852, and a DAC (D/A converter) 853.

The driver IC 85 sends a data signal (DATA) synchronous with a clock signal (CLK) from the control circuit 822 to the shift resistor 851 by using a start pulse signal (start) as a trigger. Meanwhile, the latch circuit 852 receives a latch signal (Latch) from the control circuit 822, and the data signal is latched so that the data signal is aligned at a predetermined timing in the shift resistor 851. The data signal (a digital signal) is sent to the DAC 853 in the state in which the data signal is aligned at a predetermined timing, and the DAC 853 outputs a predetermined voltage signal (an analog signal) to the above-described constant-current driving circuits 83 (the selection transistor 833).

In this instance, the above-described driving circuit 821 is an active type driving circuit, but instead of the driving circuit 821, a passive type driving circuit 821A shown in FIG. 6 may be employed. The driving circuit 821A uses a constant-current type driver IC 85A, and the selection switch 84A is switched in accordance with the select signal from the control circuit 822 to select the light emitting element 72 for every predetermined block.

Here, the plurality of constant-current driving circuits 83 and the selection switch 84 are installed on the above-described first substrate 71, which constitutes the first circuit section. Further, the driver IC 85 is a semiconductor device installed on the wiring unit 9 which will be described below.

The above-described driving circuit 821 is controlled by the control circuit 822.

The control circuit 822 is to control the operation of the driving circuit 821. The control circuit 822 controls the operation of the driving circuit 821 based on a signal from the printer controller 18 which will be described below. Here, the control circuit 822 is installed on the above-described second substrate 81, which constitutes the second circuit section.

The control, circuit 822 includes an interface circuit 86, a plurality (in this embodiment, two) of data control circuits 87, and a correction value memory 88.

The interface circuit 86 receives a signal from the printer controller 18 provided in a body (the exterior of the line head 13) of the image forming apparatus 1. In this embodiment, the interface circuit 86 is constituted by a receiving circuit using an LVDS (Low Voltage Differential Signaling), as shown in FIG. 5. The interface circuit 86 receives data deployed in the data line, together with a timing clock, from the printer controller 18, and distributes the data to each of the data control circuits 87.

The data control circuit 87 corrects the data from the interface circuit 86 to optimize an amount of luminescence of each of the light emitting elements 72, based on the correction data of the correction value memory 88, and sends the corrected data to the above-described driver IC 85 (the shift resister 851) together with the control signal.

The printer controller 18 has a function of transmitting a signal for controlling the operation of each of the light emitting elements 72 to the control circuit 822. In this embodiment, the printer controller 18 includes a head control portion 181 for controlling the operation of the line head 13, and a transmission circuit 182 for transmitting a signal from the head control portion 181 to the above-described interface circuit 86. Also, the printer controller 18 has a function of controlling each portion of the image forming apparatus 1.

Since the control circuit 822 is installed on the above-described second substrate 81, the control circuit 822 is installed to be covered by the above-described support member 6. That is, the support member 6 is disposed to cover the control circuit 822. Accordingly, it prevents the adverse electromagnetic effect, such as contamination of noise from the wiring or the like between each of the light emitting elements 72 and the control circuit 822, thereby reliably performing the exposure treatment with high precision. Also, since the circuit section 82 is installed in the support member 6, the distance between each of the light emitting elements 72 and the circuit section 82 can be shortened. For this reason, in this point, it is possible to effectively prevent the contamination of noise or the like from the wiring between each of the light emitting elements 72 and the circuit section 82.

The operation of the respective light emitting elements 72 is controlled by the control system (the circuit section 82). In this instance, the configuration of such a control system is one example, and is not limited thereto.

The circuit section 82 is electrically connected to each of the light emitting elements 72.

The wiring unit 9 includes a wiring electrically connecting the above-described light emitting substrate unit 7 and the circuit substrate unit 8.

In this embodiment, the wiring unit 9 is constituted by a plurality of flexible printed circuit substrates (FPC). Accordingly, the degree of freedom of an installation for the second substrate 81 with respect to the first substrate 71 can be increased, and thus, as described above, the second substrate 81 can be installed in such a way that its substrate surface is perpendicular to the substrate surface of the first substrate 71. In this instance, the wiring unit 9 may be constituted by single flexible printed circuit substrate (FPC).

The wiring unit 9 (flexible printed circuit substrate) is fixed to one end of each of the first substrate 71 and the second substrate 81 in its widthwise direction, as shown in FIG. 2. That is, the wiring unit (flexible printed circuit substrate) 9 is installed in such a way that the ends of the first substrate 71 and the second substrate 81 are connected to each other in a widthwise direction. Accordingly, it is possible to shorten a dimension of the line head 13 in a longitudinal direction thereof (it is possible to prevent extension of its length). The downsizing of the image forming apparatus 1 (downsizing of dimension in the main scanning direction) can be promoted by using the line head 13.

In this way, the wiring unit 9 is installed to be withdrawn from one end (a left end in FIG. 2) of the first substrate 71 in the sub-scanning direction (the second direction).

The wiring unit 9 is installed towards the development device 14. That is, in FIG. 2, the charging unit 12 is disposed at the right side of the line head 13, and the development device 14 is disposed at the left side of the line head 13.

Accordingly, even though the distance between the charging unit 12 and the development device 14 is shortened according to the downsizing of the image forming apparatus 1, the distance between the wiring unit 9 and the charging unit 12 can be largely extended. As a result, it is possible to prevent the line head 13 from being influenced by the adverse electromagnetic effect due to the charging in the charging unit 12.

In addition, since the support member 6 having the electromagnetic shielding property is interposed between the wiring unit 9 and the charging unit 12, in this point, it is possible to prevent the line head 13 from being influenced by the adverse electromagnetic effect due to the charging in the charging unit 12.

In particular, in the state in which the above-described second substrate 81 (the circuit substrate unit 8) is disposed in the support member 6, the wiring unit 9 is provided with two replicated portions 91 and 92.

The replicated portion 91 is formed by replicating upwardly the wiring unit 9 which is downwardly extended from one end of the first substrate 71, as shown in FIG. 2, and the replicated portion 92 is formed by replicating downwardly the wiring unit 9 which is upwardly extended from the replicated portion 91. Here, one of two replicated portions 91 and 92 forms a first replicated portion, and the other forms a second replicated portion.

Further, the replicated portion 91 is formed in the vicinity of one end (a lower end in FIG. 2) of the second substrate 81, and the replicated portion 92 is formed in the vicinity of the other end (an upper end in FIG. 2) of the second substrate 81. The wiring unit 9 is replicated towards the other end side from one end side of the second substrate 81.

Since the wiring unit 9 is replicated from one end side of the second substrate 81 in a widthwise direction thereof towards the other end side, it is possible to prevent wiring unit 9 from interfering with the installation of the line head 13. Furthermore, an assembling characteristic of the line head 13 can be improved, and it is possible to dispose the second substrate 81 in the support member 6.

In particular, in this embodiment, since two replicated portions 91 and 92 are installed, as described above, even though the length of the wiring unit 9 is long, the wiring unit 9 and the second substrate 81 can be installed in the support member 6. Also, as the length of the wiring unit 9 can be extended, the circuit substrate unit 8 (the second substrate 81) can be withdrawn outwardly from the support member 6, while the state, in which the light emitting substrate unit 7 (the first substrate 71) is installed on the support member 6, is maintained. As a result, it is possible to make the maintenance of the line head 13 excellent.

In addition, in this embodiment, when the light emitting substrate unit 7, the circuit substrate unit 8 and the wiring unit 9 are deployed on a plane, the wiring unit 9 (the flexible printed substrate) is bonded to the same side of the first substrate 71 and the second substrate 81. Accordingly, when the wiring unit 9 is connected to the first substrate 71 and the second substrate 81, the process can be simplified, and thus, the line head 13 can be made inexpensive.

One end of the wiring of the wiring unit 9 is connected to the wiring on the first substrate 71 by using an anisotropic conductive adhesive (ACF) or the like. In the similar way, the other end of the wiring of the wiring unit 9 is connected to the wiring on the second substrate 81 by using an anisotropic conductive adhesive (ACF) or the like.

Further, in this embodiment, the driver IC 85 constituting a portion of the above-described driving circuit 821 is installed on the wiring unit 9. Much wiring from the light emitting substrate unit 7 can be integrated on the wiring unit 9, and thus, it is possible to decrease the number of terminals and wiring required for the connection of the wiring unit 9 and the circuit substrate unit 8.

In addition, the driver IC 85 is installed at a position which is shifted towards the end side connected to the wiring unit 9 and the first substrate 71 with respect to the center of the first substrate 71 in the sub-scanning direction (the second direction). Accordingly, even though the distance between the charging unit 12 and the development device 14 is shortened according to the downsizing of the image forming apparatus 1, the distance between the driver IC 85 and the charging unit 12 can be largely extended. As a result, it is possible to prevent the line head 13 from being influenced by the electromagnetic effect due to the charging in the charging unit 12.

Further, the driver IC 85 is disposed to come into contact with the inner surface of the above-described light shielding member 19. Accordingly, the heat generated from the driver IC 85 can be radiated (heat radiation) to the light shielding member 19. As a result, the reliability of the line head 13 can be improved by preventing the damage or malfunction of the driver IC 85 due to the heat.

The driver IC 85 may come into direct contact with the light shielding member 19, and a sheet having a heat dissipating characteristic is interposed between the driver IC 85 and the light shielding member 19. If the sheet having a heat dissipating characteristic is interposed between the driver IC 85 and the light shielding member 19, it is possible to prevent the damage of the driver IC 85 due to the contacting with the light shielding member 19.

With the image forming apparatus 1 described above, since the wiring unit 9 (the wiring section) is installed towards the development device 14 (the development device), even though the distance between the charging unit 12 and the development device 14 is shortened according to the downsizing of the image forming apparatus 1, the distance between the wiring unit 9 and the charging unit 12 can be largely extended. As a result, it is possible to prevent the line head 13 from being influenced by the electromagnetic effect due to the charging in the charging unit 12.

Further, since the support member 6 having the electromagnetic shielding property is interposed between the wiring unit 9 and the charging unit 12, in this point, it is possible to prevent the line head 13 from being influenced by the adverse electromagnetic effect due to the charging in the charging unit 12.

Furthermore, since the lens array 16 is installed at a position shifted to the other end side opposite to the withdrawn side of the wiring unit 9 with respect to the center of the first substrate 71 in the sub-scanning direction, even though the distance between the charging unit 12 and the development device 14 is shortened according to the downsizing of the image forming apparatus 1, the distance between the exposed position of the light receiving surface 111 by the line head 13 and the developed position by the development device 14 can be largely extended. As a result, even though the speed increase is promoted, a time needed until the exposed portion of the light receiving surface 111 is changed into a potential required for the development after the exposure treatment can be ensured, thereby performing proper development.

In this point, the image forming apparatus 1 can obtain an image of high quality, as well as promoting the downsizing and speed-up.

### Second Embodiment

A second embodiment of the invention will now be described.

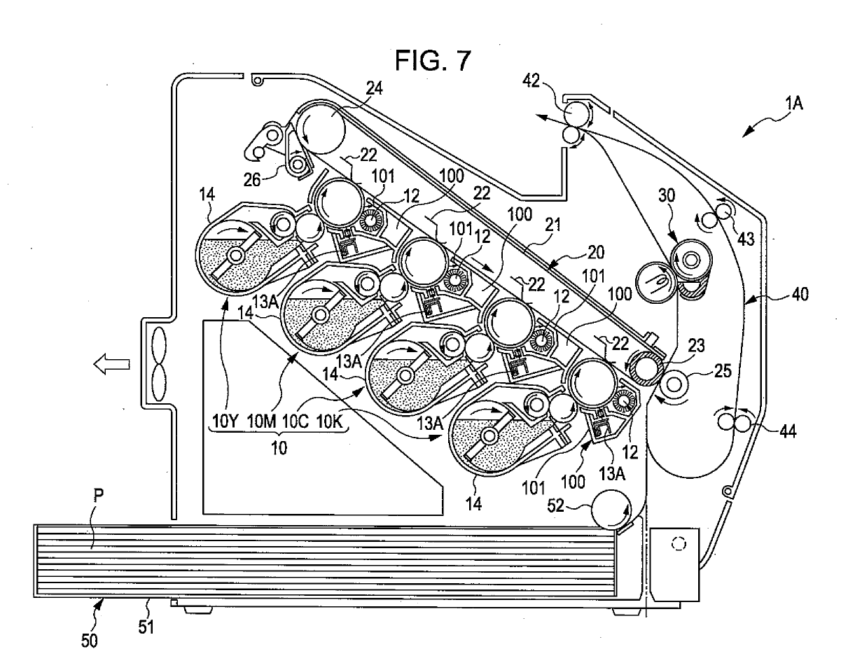

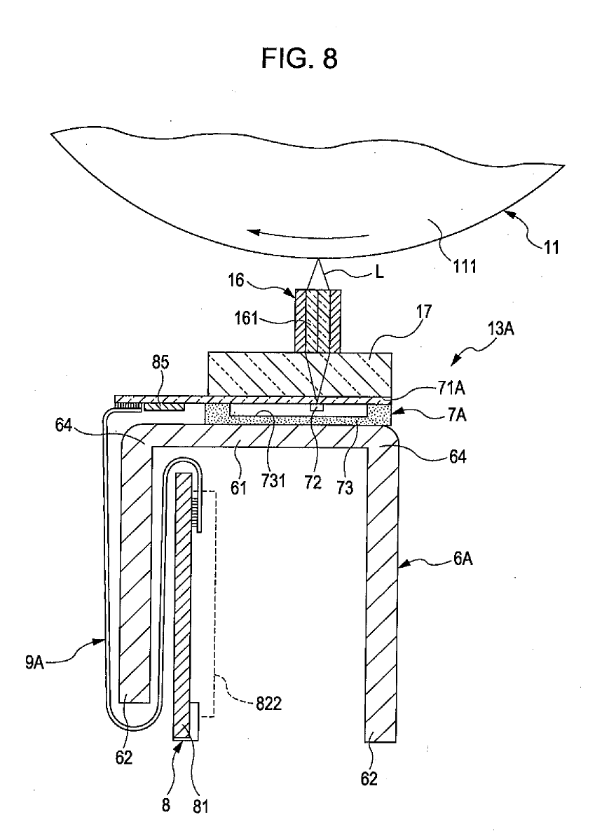

FIG. 7 is a schematic view showing the entire configuration of an image forming apparatus according to the second embodiment of the invention. FIG. 8 is a transverse cross-sectional view of a line head equipped in the image forming apparatus shown in FIG. 7.

The image forming apparatus of the second embodiment will now be described based on differences between the first and second embodiments described above, and the same items thereof will not be described herein. In FIGS. 7 and 8, the same components as those in the above-described first embodiment are shown by like reference numerals.

The image forming apparatus 1A of the embodiment is identical to the image forming apparatus 1 of the above-described first embodiment, except for unitization (provided as a cartridge) of the photosensitive drum (the latent image carrier) and the line head.

In the image forming apparatus 1A of the embodiment includes, as shown in FIG. 7, each of image forming stations 10Y, 10M, 10C and 10K has a photosensitive body unit 100 which is a latent image carrier unit.

The photosensitive drum unit 100 includes a casing 101, a photosensitive drum 11, a line head 13A, and a charging unit 12.

The casing 101 receives and holds the line head 13A, the photosensitive drum 11, and the charging unit 12. The casing 101 is detachably connected to a body of the image forming apparatus 1A. Accordingly, the line head 13A, the charging unit 12 and the photosensitive drum 11 can be simultaneously substituted simply.

A constituent material of the casing 101 is not particularly limited, and, for example, a resin material, a metal material or the like may be used.

Further, it is preferable that the casing 101 has an electromagnetic shielding property. Accordingly, the casing 101 has the same function as that of the light shielding member 19 (the shield member) of the above-described first embodiment. As a result, it is possible to simplify the configuration of the photosensitive body unit 100.

The line head 13A includes, as shown in FIG. 8, a support member 6A, a light emitting substrate unit 7A, a circuit substrate unit 8A, a wiring unit (a flexible printed circuit substrate) 9A, a lens array 16, and a spacer 17.

The support member 6A is formed, for example, by bending a metal plate, and includes a substrate mounting portion 61, a pair of leg portions 62, and a bent portion 64 formed between the substrate mounting portion 61 and the respective leg portions 62. The support member 6 has a transverse cross section of an approximately U-shape.

A first substrate 71A of the light emitting substrate unit 7A is mounted on one surface side (an upper portion in FIG. 8) of the substrate mounting portion 61 of the support member 6, with a sealing member 73 being interposed therebetween.

The wiring unit 9A is installed to be withdrawn from one end (a left end in FIG. 8) of a lower surface of the first substrate 71A in a sub-scanning direction (a second direction).

In addition, the driver IC 85 is installed in the vicinity of a connection portion between the first substrate 71A and the wiring unit 9A in a lower surface of the first substrate 71A. That is, the driver IC 85 is installed at a position which is shifted to the other end side connected to the wiring unit 9 and the first substrate 71 with a center of the first substrate 71 in a sub-scanning direction (a second direction).

Therefore, even though the distance between the charging unit 12 and the development device 14 is shortened according to the downsizing of the image forming apparatus 1A, the distance between the driver IC 85 and the charging unit 12 can be largely extended. As a result, it is possible to prevent the line head 13 from being influenced by the adverse electromagnetic effect due to the charging in the charging unit 12.

With the image forming apparatus 1A as described above, the same effect as that of the image forming apparatus 1 according to the first embodiment described above can be obtained.

### Third Embodiment

A third embodiment of the invention will now be described.

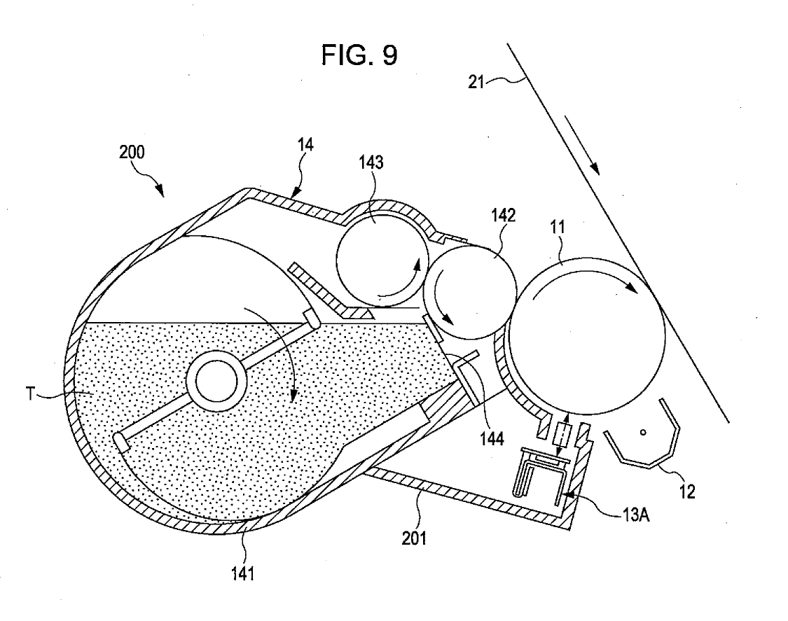

FIG. 9 is a transverse cross-sectional view of a development unit according to a third embodiment of the invention.

The image forming apparatus of the third embodiment will now be described based on differences between the third embodiment and the first and second embodiments described above, and the same items thereof will not be described herein. In FIG. 9, the same components as those in the above-described first and second embodiments are shown by like reference numerals.

The image forming apparatus of the embodiment is identical to the image forming apparatus 1 of the first embodiment or the image forming apparatus 1A of the second embodiment described above, except for unitization (provided as a cartridge) of the development device and the line head.

The image forming apparatus of the embodiment includes a development unit 200, as shown in FIG. 9.

The development unit 200 includes a casing 201, a line head 13A, and a development device 14 which is a developing section.

The development device 14 has a housing 141 filled with toner T which is a developing agent, a developing roller 142 which is a developing agent carrier, a toner supply roller 143 that supplies the toner T to the developing roller 142, and a restriction blade 144 that restricts a layer thickness of the toner T carried on the developing roller 142.

The housing 141 receives the toner T in the internal space thereof. The toner supply roller 143 and the developing roller 142 are supported in the housing 141. Also, the restriction blade 144 is attached to the housing 141, and is pressed on the developing roller 142.

The roller 142 carries the toner T on its outer circumference, and transfers the toner T to a developing position (hereinafter, referred to as “a developing position”) opposite to the developing roller 142 and the photosensitive drum 11. The developing roller 142 is formed in a cylindrical shape, and can rotate around its axis. In this embodiment, the developing roller 142 rotates in a direction contrary to a rotation direction of the photosensitive drum 11.

Further, at the time of development by the development device 14 in the embodiment, the developing roller 142 and the photosensitive drum 11 are faced to each other in a non-contact state, in the state in which there is a minute gap between the developing roller 142 and the photosensitive drum 11. The toner T is scattered from the developing roller 142 to the photosensitive drum 11 by applying an alternating electric field between the developing roller 142 and the photosensitive drum 11, thereby developing the latent image on the photosensitive drum 11.

The toner supply roller 143 supplies the toner T accommodated in the housing 141 to the developing roller 142. The toner supply roller 143 is made of, for example, polyurethane foam, and is pressed on the developing roller 142 in the state of elastic deformation. In this embodiment, the toner supply roller 143 rotates in a direction contrary to a rotation direction of the developing roller 142. Also, the toner supply roller 143 has a function of supplying the toner T accommodated in the housing 141 to the developing roller 142, and also has a function of stripping the developing roller 142 of the toner T which remains on the developing roller 142 after development.

The restriction blade 144 restricts the layer thickness of the toner T carried on the developing roller 142, and simultaneously, applies an electric charge to the toner T carried on the developing roller 142 due to frictional charging. The restriction blade 144 also serves as a sealing member at an upstream side of the developing position in the rotation direction of the developing roller 142.

The casing 201 is integrally formed with the housing 141 described above. In other words, the above-described housing 141 constitutes a portion of the casing 201.

The casing 201 holds the line head 13A and the developing device 14. The casing 201 is detachably connected to a body of the image forming apparatus. Accordingly, the line head 13A and the developing device 14 can be simultaneously substituted simply.

A constituent material of the casing 201 is not particularly limited, and, for example, a resin material, a metal material or the like may be used.

In addition, it is preferable that the casing 201 has an electromagnetic shielding property. Accordingly, the casing 201 has the same function as that of the light shielding member 19 (shield member) of the above-described first embodiment. As a result, it is possible to simplify the configuration of the development unit 200.

With the image forming apparatus as described above, the same effect as that of the image forming apparatus 1 according to the first embodiment described above can be obtained.

### Fourth Embodiment

A fourth embodiment of the invention will now be described.

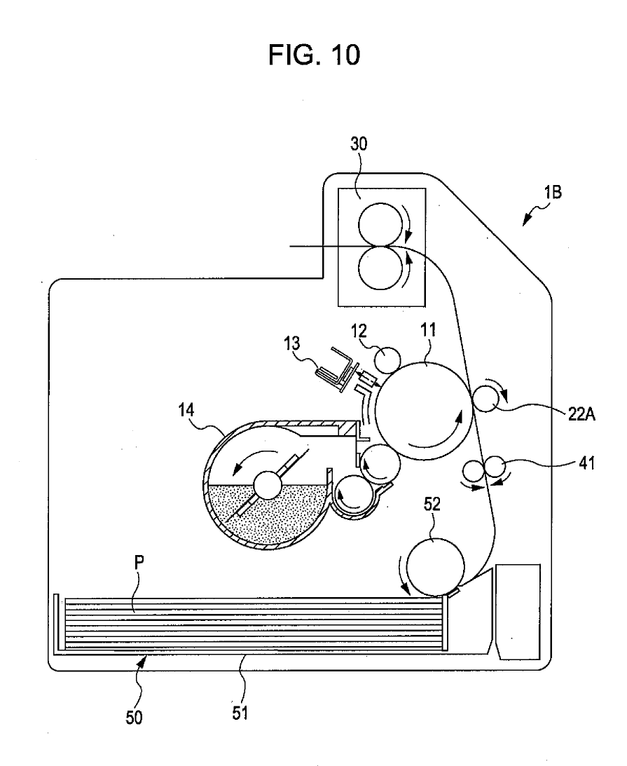

FIG. 10 is a schematic view showing the entire configuration of an image forming apparatus according to a fourth embodiment of the invention.

The image forming apparatus 1B of the fourth embodiment will now be described based on differences between the fourth embodiment and the first embodiment, and the same items thereof will not be described herein. In FIG. 10, the same components as those in the above-described first or second embodiment are shown by like reference numerals.

The image forming apparatus 1B of the embodiment is a printer of single color (monochrome).

The image forming apparatus 1B includes a photosensitive drum (photosensitive body) 11 which is a latent image carrier carrying an electrostatic latent image, and a charging unit (charger) 12, a line head (exposure unit) 13, a development device (developing section) 14 and a cleaning unit 15 are disposed around (an outer circumference side) the photosensitive drum.

Further, the image forming apparatus 1B includes a transfer roller 22A that transfers an toner image on a recording medium P from the photosensitive drum 11, a fixing unit 30 for a fixing process, a transport mechanism 40 that transports the recording medium P such as paper, and a paper feeding unit 50 that supplies the recording medium P to the transport mechanism 40.

The image forming apparatus 1B of monochromatic type can obtain the same effect as that of the image forming apparatus 1 according to the above-described first embodiment. That is, a compact monochromatic printer which forms an image of high quality at high speed can be provided.

Although the image forming apparatus and the latent image carrier unit according to the invention are described above, the invention is not limited thereto, and each component constituting the image forming apparatus or the like may be substituted by any component exhibiting the same function. Also, any components may be added.

In addition, the lens array is not limited to the arrangement in which a plurality of lenses are disposed in a matrix pattern of two columns and n rows, and, for example, the lenses may be disposed in a matrix pattern of three columns and n rows, or four columns and n rows.

Further, a micro-lens array with a plurality of arranged micro-lenses may be used as the lens array.

In addition, in the above-described embodiment, for descriptive convenience, although the case in which the light emitting elements arranged by one column and n rows is described, the invention is not limited thereto, and the light emitting elements may be arranged in a matrix type of two columns and n rows, three columns and n rows, or the like.

Further, in the above-described second embodiment, the charging unit 12 is not held in the casing 101, but may be held in the body of the image forming apparatus 1A.

In addition, in the above-described third embodiment, the photosensitive drum 11 may be held in the casing 201 and then be provided as a cartridge.

The entire disclosure of Japanese Patent Applications No. 2009-043225, filed on Feb. 25, 2009 is expressly incorporated by reference herein.

What is claimed is:

1. An image forming apparatus comprising:
a latent image carrier on which a latent image is formed;
a line head that exposes the latent image carrier; and
a developing section that develops the latent image,
wherein the line head includes,
a substrate;
a light emitting element disposed on the substrate in a first direction; and
a wiring installed on the substrate so as to be withdrawn from one end of the substrate in a second direction perpendicular to or substantially perpendicular to the first direction,
in which the one end is disposed to be the developing section side.

2. The image forming apparatus according to claim 1, wherein the line head includes a lens array that focuses a light from the light emitting element, and
the lens array is disposed at a position shifted to the other end side opposite to one end side with respect to an imaginary center line of the substrate in a second direction.

3. The image forming apparatus according to claim 1, wherein the line head includes a shield member having a magnetic shielding property and disposed to cover the wiring.

4. The image forming apparatus according to claim 1, wherein the line head includes a semiconductor device constituting at least a portion of a driving circuit that drives the light emitting element, and the semiconductor device is disposed at a position shifted to the one end side with respect to an imaginary center line of the substrate in a second direction.

5. The image forming apparatus according to claim 4, wherein the semiconductor device is disposed on the substrate.

6. The image forming apparatus according to claim 4, wherein the semiconductor device is disposed on the wiring.

7. A latent image carrier unit comprising:
a latent image carrier on which a latent image is formed;
a line head that forms the latent image on the latent image carrier; and
a developing section that develops the latent image,
wherein the line head includes,
a substrate;
a light emitting element disposed on the substrate in a first direction; and
a wiring installed on the substrate so as to be withdrawn from one end of the substrate in a second direction perpendicular to or substantially perpendicular to the first direction,
in which the one end of the line head is disposed to be the developing section side.
